(19) United States
(12) Patent Application Publication
(10) Pub. No.: US 2026/0171705 A1
(43) Pub. Date: Jun. 18, 2026

(54) Electrical Connector Insert Having Internal Retention Clips

(71) Applicant: TE Connectivity Corporation, Schaffhausen (CH)

(72) Inventors: Jack BROWN, Hastings (GB); Xiaoming LUO, Hummelstown, PA (US); Christopher A. SHIPMAN, Mechanicsburg, PA (US); Andrew MORRIS, Harrisburg, PA (US)

(73) Assignee: TE Connectivity Corporation, Schaffhausen (CH)

(21) Appl. No.: 18/985,215

(22) Filed: Dec. 18, 2024

(51) Int. Cl. H01R 13/42

(52) U.S. Cl. CPC H01R 13/42

(57) ABSTRACT

An electrical connector which has a single unitary one-piece dielectric housing with a mating surface and an assembly surface. One or more terminal receiving passageways extend between the mating surface and the assembly surface. Contact retention clip receiving recesses are provided in the one or more terminal receiving passageways. The contact retention clip receiving recesses have larger diameters than diameters of remaining portions of the terminal receiving passageways. Contact retention clips are positioned in the contact retention clip receiving recesses. The contact retention clips have unstressed diameters which are larger than the diameters of the contact retention clip receiving passageways. The contact retention clips exert force on walls of the contact retention clip receiving recesses.

### FIELD OF THE INVENTION

The invention relates to an electrical connector assembly. In particular, an electrical connector with an internal undercut to position and maintain contact retention clips therein.

### BACKGROUND OF THE INVENTION

Housings for electrical contacts are typically multiple pieces that require the expense and difficulty of assembling and locking them together. In order to trap retention clips and crimped contacts in a housing, supporting surfaces are required to hold the components from pushing through as well as pulling out of the plastic housing.

It would therefore be beneficial to provide a single piece electrical connector housing or insert which has an internal undercut or stepped internal feature which enables a contact retention clip to be inserted and retained such that a force can be applied in the forward and rearward direction without the retention clip becoming dislodged.

### SUMMARY OF THE INVENTION

The following provides a summary of certain illustrative embodiments of the present invention. This summary is not an extensive overview and is not intended to identify key or critical aspects or elements of the present invention or to delineate its scope.

An object is to provide a single piece electrical connector housing or insert which has an internal undercut or stepped internal feature which enables a contact retention clip to be inserted and retained therein.

An object is to provide a contact retention clip that is compressed and installed from the rear of the insert through a diameter smaller than that of the undercut. Once the compressed clip reaches the necessary depth, it recovers outward to seat in position within the undercut and is non-removable.

An embodiment is directed to an electrical connector which has a single unitary one-piece dielectric housing with a mating surface and an assembly surface. One or more terminal receiving passageways extend between the mating surface and the assembly surface. Contact retention clip receiving recesses are provided in the one or more terminal receiving passageways. The contact retention clip receiving recesses have larger diameters than diameters of remaining portions of the terminal receiving passageways. Contact retention clips are positioned in the contact retention clip receiving recesses. The contact retention clips have unstressed diameters which are larger than the diameters of the contact retention clip receiving passageways. The contact retention clips exert force on walls of the contact retention clip receiving recesses.

An embodiment is directed to an electrical connector which has a single unitary one-piece dielectric housing with a mating surface and an assembly surface. One or more terminal receiving passageways extends between the mating surface and the assembly surface. Terminals are positioned in the one or more terminal receiving passageways. Contact retention clip receiving recesses are provided in the one or more terminal receiving passageways. The contact retention clip receiving recesses have larger diameters than diameters of remaining portions of the terminal receiving passageways. Contact retention clips are positioned in the contact retention clip receiving recesses. The contact retention clips have unstressed diameters which are larger than the diameters of the contact retention clip receiving passageways. The contact retention clip receiving recesses having first slots extending from first ends of the contact retention clips to second ends of the contact retention clips. The contact retention clips exert force on walls of the contact retention clip receiving recesses. The contact retention clips cooperate with the terminals to retain the terminals in the one or more terminal receiving passageways.

An embodiment is directed to an electrical connector which has a single unitary one-piece dielectric housing with a mating surface and an assembly surface. One or more terminal receiving passageways extend between the mating surface and the assembly surface. Terminals are positioned in the one or more terminal receiving passageways. Contact retention clip receiving recesses are provided in the one or more terminal receiving passageways. The contact retention clip receiving recesses have larger diameters than diameters of remaining portions of the terminal receiving passageways. The contact retention clip receiving recesses have first shoulders and oppositely facing second shoulders, the shoulders are internal undercuts or stepped internal features formed during in the single unitary one-piece dielectric housing. Cylindrical C-shaped contact retention clips are positioned in the contact retention clip receiving recesses. The contact retention clips have unstressed diameters which are larger than the diameters of the contact retention clip receiving passageway. The contact retention clip receiving recesses have first slots which extend from first ends of the contact retention clips to second ends of the contact retention clips, the first slots allow the contact retention clips to be compressed and to be inserted into the one or more respective terminal receiving passageway. The contact retention clips cooperate with the terminals to retain the terminals in the one or more terminal receiving passageways.

### BRIEF DESCRIPTION OF THE DRAWINGS

FIG. 1 is a front perspective view of an electrical connector with an outer housing or shell shown in cross-section.

FIG. 2 is a front perspective view of an inner housing or insert of the first electrical connector of FIG. 1 with a contact retention clip shown prior to insertion into a contact receiving passageway.

FIG. 3 is a view similar to FIG. 2, with the contact retention clip moved into positioned relative to the first contact receiving passageway.

FIG. 4 is a cross-sectional view of the inner housing or insert of FIG. 2 with the contact retention clip partially inserted into the contact receiving passageway.

FIG. 5 is a cross-sectional view of the inner housing or insert, similar to that of FIG. 4, with the contact retention clip fully inserted into the contact receiving passageway.

FIG. 6 is a cross-sectional view of the inner housing or insert, similar to that of FIG. 5, with the contact retention clip fully inserted into the contact receiving passageway and a female or socket contact positioned in the contact receiving passageway.

FIG. 7 is a cross-sectional view of the inner housing or insert, similar to that of FIG. 5, with the contact retention clip fully inserted into the contact receiving passageway and a male or pin contact positioned in the contact receiving passageway.

FIG. 8 is a perspective view of the illustrative contact retention clip shown in FIG. 2

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

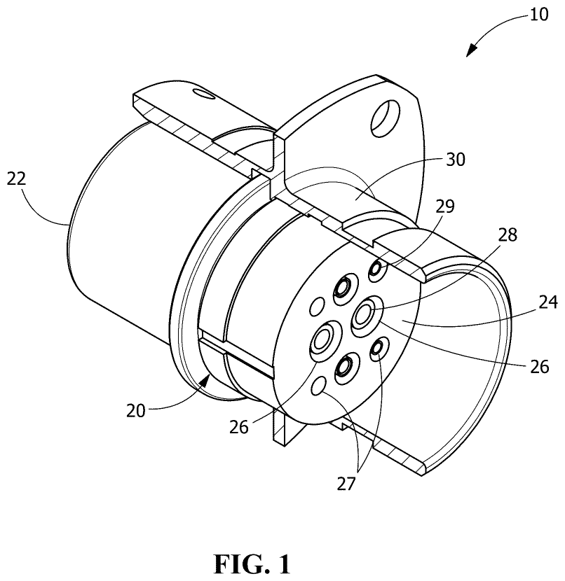

As shown in FIG. 1, an electrical connector assembly 10 includes a single unitary one-piece dielectric housing or insert 20. In the illustrative embodiment shown, the first connector assembly 10 is a circular connector, but other configurations of connectors can be used.

The single unitary one-piece dielectric housing or insert 20 has a mating surface 22, an assembly surface 24, and a plurality of terminal receiving passageways 26, 27 extending therebetween. The terminal receiving passageways 26 have a larger diameter than the terminal receiving passageways 27. Connector 10 includes a plurality of signal terminals 28 disposed in respective terminal receiving passageway 26 and ground terminals 29 disposed in respective terminal receiving passageway 27. The terminals 28, 29 are terminated to respective conductors (not shown). In the illustrative embodiment shown, the terminals 28, 29 are socket terminals, but other types of terminals may be used. Connector 10 includes a conductive shell 30 disposed around dielectric housing 20.

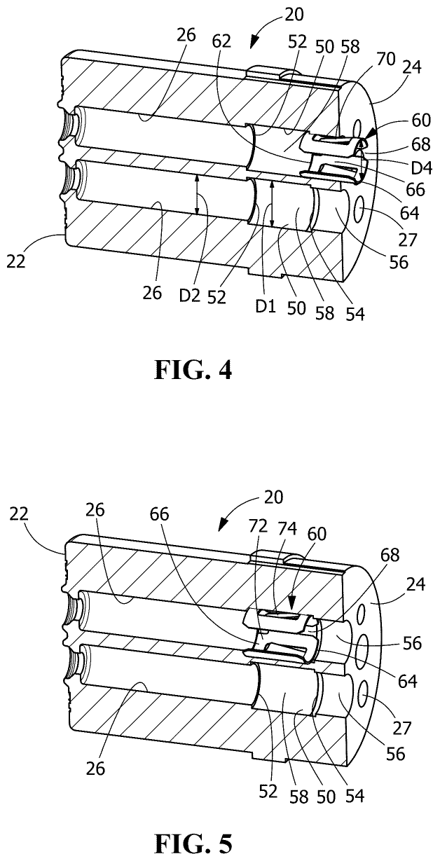

Each of the terminal receiving passageways 26 has a cylindrical contact retention clip receiving recess 50 which is positioned between the mating surface 22 and the assembly surface 24, as is shown in FIGS. 4 through 7. As shown in FIG. 4, the cylindrical contact retention clip receiving recesses 50 have larger diameters D1 than the diameters D2 of the remaining portions of the terminal receiving passageways 26. Each of the terminal receiving passageways 27 may also have a smaller cylindrical contact retention clip receiving recess (not shown) which is positioned between the mating surface 22 and the assembly surface 24. The smaller cylindrical contact retention clip receiving recesses have larger diameters than the diameters of the remaining portions of the terminal receiving passageways 27. Except for the relative size of the contact retention clip receiving recesses 50 and the smaller contact retention clip receiving recesses, they are identical. Therefore, for ease of explanation and understanding, only the cylindrical contact retention clip receiving recess 50 will be discussed.

Referring to FIGS. 4 through 7, each contact retention clip receiving recess 50 has a first shoulder 52 and an oppositely facing second shoulder 54. The shoulders 52, 54 are internal undercuts or stepped internal features which are formed during the manufacture of the single unitary one-piece dielectric housing or insert 20. In the illustrative embodiment shown, the shoulders 52, 54 extend about the entire circumference of the terminal receiving passageways 26 and extend at essentially 90 degree angles from the walls 56 of the terminal receiving passageways 26 and essentially 90 degree angles from the walls 58 of the retention clip receiving recesses 50. However, other configurations of the shoulder 52, 54 may be used, such as but not limited to, the shoulders 52, 54 being spaced periodically about the circumference rather than extending about the entire circumference of the terminal receiving passageways 26.

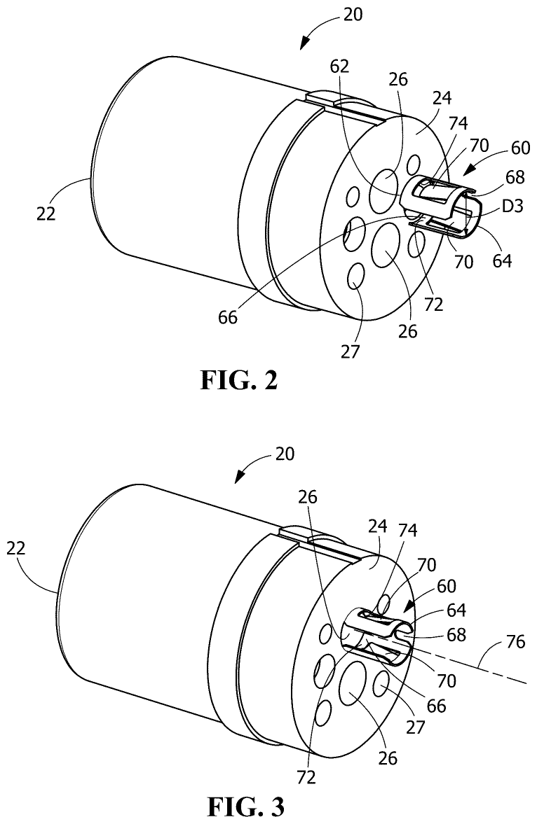

As shown in FIGS. 2 through 7, contact retention clips 60 are provided to be positioned in terminal receiving passageways 26. In the figures, only one contact retention clip 60 is shown, however, contact retention clips 60 may be positioned more than one or all of the terminal receiving passageways 26. Additional contact retention clips (not shown) may be provided in terminal receiving passageways 27. The contact retention clips for terminal receiving passageways 27 may be identical to contact retention clips 60, with the exception that the size is smaller than contact retention clips 60.

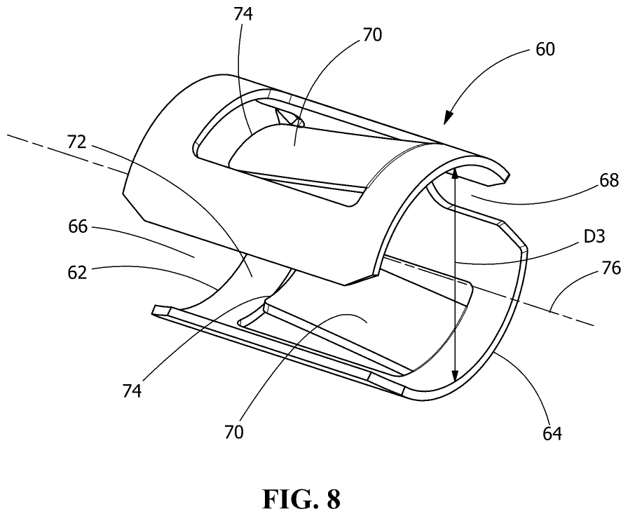

As shown in FIG. 8, each contact retention clip 60 is a flexible clip, such as a cylindrical metal C-clip, that may be compressed and expanded. The contact retention clip 60 has a unstressed diameter D3 (as shown in FIG. 3) which is larger than the diameter D2 of the terminal receiving passageway 26 and larger than the diameter of the contact retention clip receiving recess 50. However, the contact retention member may be any known flexible member for retaining an electrical contact.

In the illustrative embodiment shown, the contact retention clip 60 has a first end 62 and an oppositely facing second end 64. A slot or opening 66 extends from the first end 62 to the second end 64. A second slot or opening 68 extends from the second end 64 toward the first end 62. The slot or opening 66 and the second slot or opening 68 allow the contact retention clip 60 to be flexible such that it can be compressed or squeezed to be inserted into a respective terminal receiving passageway 26. One or more retention arms 70 extends from the wall 72 of the contact retention clip 60. The retention arms 70 have free ends 74 which extend toward a longitudinal axis 76 (FIG. 3) of the contact retention clip 60.

During assembly, a respective contact retention clip 60 is moved into alignment with a respective terminal receiving passageways 26, as represented by FIG. 2. In order to insert the contact retention clip 60 into the terminal receiving passageways 26, the contact retention clip 60 is compressed, such that a compressed diameter D4 (FIG. 4) of the contact retention clip 60 is less than the diameters D2 of the terminal receiving passageway 26, as shown in FIG. 3.

With the contact retention clip 60 compressed, the contact retention clip 60 is moved into the terminal receiving passageway 26, as shown in FIG. 4. Insertion of the contact retention clip 60 continues until the contact retention clip 60 reaches the contact retention clip receiving recess 50. As this occurs, the contact retention clip 60 expands toward its unstressed position. However, as the diameter D1 of the contact retention clip receiving recess 50 is less than the unstressed diameter D3 of the contact retention clip 60, the contact retention clip 60 exerts a force on the wall 58 of the contact retention clip receiving recess 50, as shown in FIG. 5. As the contact retention clip 60 expands into the contact retention clip receiving recess 50, the contact retention clip 60 to is secured or fully inserted into the contact retention clip receiving recess 50.

In the secured or fully inserted or fully inserted position, the first end 62 of the contact retention clip 60 is adjacent to or in contact with the first shoulder 52 the contact retention clip receiving recess 50 and the second end 64 is adjacent to or in contact with the second shoulder 54. The cooperation of the ends 62, 64 with the shoulders 52, 54 retain the contact retention clip 60 in the contact retention clip receiving recess 50, as shown in FIG. 5.

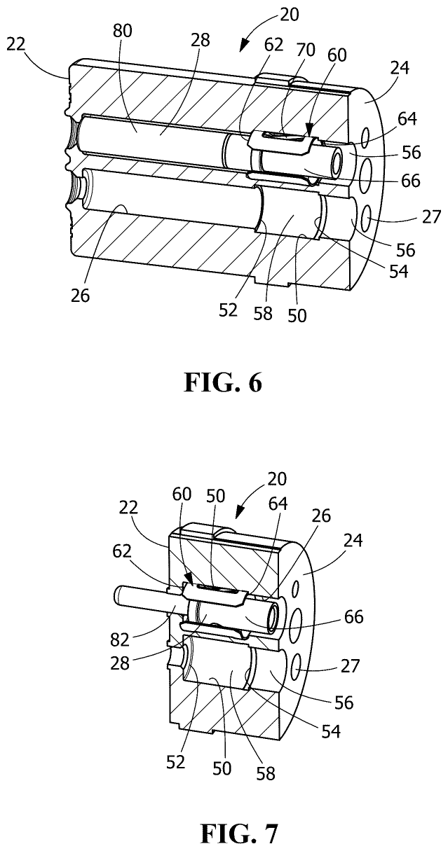

With the contact retention clip 60 properly secured in the contact retention clip receiving recess 50, a female or socket contact 80 (as shown in FIG. 6) or a male or pin contact 82 (as shown in FIG. 7) may be inserted into the terminal receiving passageway 26 through the assembly surface 24 of the single unitary one-piece housing dielectric housing or insert 20. The one or more retention arms 70 of the contact retention clip 60 engage either the contact 80 or contact 82 to retain the contact in the terminal receiving passageway 26.

The single piece electrical connector housing or insert 20 with an internal undercut or stepped contact retention clip receiving recess 50 allows for a contact retention clip 60 to be inserted and retained in the contact retention clip receiving recess 50 such that a force applied in the forward and rearward direction of the terminal receiving passageway 26 does not cause the contact retention clip 60 from becoming dislodged. The configuration of the internal undercut or stepped contact retention clip receiving recess 50 and the use of the compressible contact retention clip 60 allows the insert 20 to be manufactured in one piece, thereby simplifying manufacturing and reducing cost as compared to the multiple piece housings or inserts of the known art.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. An electrical connector comprising:
a single unitary one-piece dielectric housing having a mating surface and an assembly surface;
one or more terminal receiving passageways extending between the mating surface and the assembly surface;
contact retention clip receiving recesses provided in the one or more terminal receiving passageways, the contact retention clip receiving recesses having larger diameters than diameters of remaining portions of the terminal receiving passageways;
contact retention clips positioned in the contact retention clip receiving recesses, the contact retention clips having unstressed diameters which are larger than the diameters of the contact retention clip receiving passageways, the contact retention clips exert force on walls of the contact retention clip receiving recesses.

2. The electrical connector as recited in claim 1, wherein the contact retention clip receiving recesses have first shoulders and oppositely facing second shoulders, the shoulders are internal undercuts or stepped internal features formed during in the single unitary one-piece dielectric housing.

3. The electrical connector as recited in claim 2, wherein the first shoulders and the second shoulders extend about the entire circumference of the one or more terminal receiving passageways.

4. The electrical connector as recited in claim 2, wherein the first shoulders and the second shoulders extend at essentially 90 degree angles from walls of the one or more terminal receiving passageways and essentially 90 degree angles from walls of the retention clip receiving recesses.

5. The electrical connector as recited in claim 1, wherein contact retention clips have a cylindrical C-shaped which may be compressed and expanded.

6. The electrical connector as recited in claim 1, wherein the contact retention clips have first ends and an oppositely facing second ends, first slots extend from the first ends to the second ends, the first slots allow the contact retention clips to be flexible such that they can be compressed or squeezed to be inserted into the one or more respective terminal receiving passageway.

7. The electrical connector as recited in claim 6, wherein second slots extend from the second ends toward the first ends.

8. The electrical connector as recited in claim 6, wherein one or more retention arms extend from a wall of the contact retention clip, the one or more retention arms have free ends which extend toward longitudinal axes of the contact retention clip.

9. An electrical connector comprising:
a single unitary one-piece dielectric housing having a mating surface and an assembly surface;
one or more terminal receiving passageways extending between the mating surface and the assembly surface;
terminals positioned in the one or more terminal receiving passageways;
contact retention clip receiving recesses provided in the one or more terminal receiving passageways, the contact retention clip receiving recesses having larger diameters than diameters of remaining portions of the terminal receiving passageways;
contact retention clips positioned in the contact retention clip receiving recesses, the contact retention clips having unstressed diameters which are larger than the diameters of the contact retention clip receiving passageways, the contact retention clip receiving recesses having first slots extending from first ends of the contact retention clips to second ends of the contact retention clips, the contact retention clips exerting force on walls of the contact retention clip receiving recesses, the contact retention clips cooperate with the terminals to retain the terminals in the one or more terminal receiving passageways.

10. The electrical connector as recited in claim 9, wherein the contact retention clip receiving recesses have first shoulders and oppositely facing second shoulders, the shoulders are internal undercuts or stepped internal features formed during in the single unitary one-piece dielectric housing.

11. The electrical connector as recited in claim 10, wherein the first ends of the contact retention clips are adjacent to or in contact with the first shoulders of the contact retention clip receiving recesses and the second ends of the contact retention clips are adjacent to or in contact with the second shoulders of the contact retention clip receiving recesses, wherein the contact retention clips are retained in the contact retention clip receiving recesses.

12. The electrical connector as recited in claim 11, wherein the first shoulders and the second shoulders extend about the entire circumference of the one or more terminal receiving passageways.

13. The electrical connector as recited in claim 12, wherein the first shoulders and the second shoulders extend at essentially 90 degree angles from walls of the one or more terminal receiving passageways and essentially 90 degree angles from walls of the retention clip receiving recesses.

14. The electrical connector as recited in claim 13, wherein contact retention clips have a cylindrical C-shaped which may be compressed and expanded.

15. The electrical connector as recited in claim 14, wherein second slots extend from the second ends toward the first ends.

16. The electrical connector as recited in claim 15, wherein one or more retention arms extend from a wall of the contact retention clip, the one or more retention arms have free ends which extend toward longitudinal axes of the contact retention clip.

17. An electrical connector comprising:
a single unitary one-piece dielectric housing having a mating surface and an assembly surface;
one or more terminal receiving passageways extending between the mating surface and the assembly surface;
terminals positioned in the one or more terminal receiving passageways;
contact retention clip receiving recesses provided in the one or more terminal receiving passageways, the contact retention clip receiving recesses having larger diameters than diameters of remaining portions of the terminal receiving passageways, the contact retention clip receiving recesses having first shoulders and oppositely facing second shoulders, the shoulders are internal undercuts or stepped internal features formed during in the single unitary one-piece dielectric housing;
cylindrical C-shaped contact retention clips positioned in the contact retention clip receiving recesses, the contact retention clips having unstressed diameters which are larger than the diameters of the contact retention clip receiving passageways, the contact retention clip receiving recesses having first slots extending from first ends of the contact retention clips to second ends of the contact retention clips, the first slots allow the contact retention clips to be compressed and to be inserted into the one or more respective terminal receiving passageway, the contact retention clips cooperate with the terminals to retain the terminals in the one or more terminal receiving passageways.

18. The electrical connector as recited in claim 10, wherein the first ends of the contact retention clips are adjacent to or in contact with the first shoulders of the contact retention clip receiving recesses and the second ends of the contact retention clips are adjacent to or in contact with the second shoulders of the contact retention clip receiving recesses, wherein the contact retention clips are retained in the contact retention clip receiving recesses.

19. The electrical connector as recited in claim 11, wherein the first shoulders and the second shoulders extend about the entire circumference of the one or more terminal receiving passageways.

20. The electrical connector as recited in claim 12, wherein the first shoulders and the second shoulders extend at essentially 90 degree angles from walls of the one or more terminal receiving passageways and essentially 90 degree angles from walls of the retention clip receiving recesses.
